(19) United States
(12) Patent Application Publication
(10) Pub. No.: US 2008/0153553 A1
(43) Pub. Date: Jun. 26, 2008

(54) Radio communication terminal and radio communication system

(75) Inventors: Tomoya Horiguchi, Inagi-shi (JP); Tazuko Tomioka, Kawasaki-shi (JP); Ren Sakata, Yokohama-shi (JP)

Correspondence Address: Charles N. J. Ruggiero, Esq.;Ohlandt, Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 11/888,513

(22) Filed: Aug. 1, 2007

(30) Foreign Application Priority Data
Dec. 26, 2006 (JP) 2006-350008

(51) Int. Cl. H04B 1/38

(52) U.S. Cl. 455/567

(57) ABSTRACT

A radio communication terminal includes a first transmitting unit configured to transmit a beacon, a second transmitting unit configured to transmit a first notifying signal which includes information of a frequency of the beacon and a transmission timing of the beacon, a measuring unit configured to measure a reception power of a signal transmitted by each of a plurality of slave radio communication terminals, a selecting unit configured to select a notifying radio communication terminal, which is to transmit a second notifying signal, from the slave radio communication terminals based on the reception power, the second notifying signal including the same information of the frequency of the beacon and the transmission timing of the beacon as the information included in the first notifying signal, and a third transmitting unit configured to transmit, to the notifying radio communication terminal, notifying instruction information including an instruction to transmit the second notifying signal.

### CROSS-REFERENCE TO RELATED APPLICATIONS

This application is based upon and claims the benefit of priority from prior Japanese Patent Application No. 2006-350008, filed Dec. 26, 2006, the entire contents of which are incorporated herein by reference.

### BACKGROUND OF THE INVENTION

1. Field of the Invention

The present invention relates to a radio communication system, in particular, a radio communication terminal and a radio communication system in which a plurality of terminals form a network.

2. Description of the Related Art

In conventional ad hoc networks, for example, a master terminal selects a master terminal candidate from a plurality of slave terminals, and notifies them of priorities thereof. Thereby, when a notifying signal is not broadcasted from the master terminal for a predetermined time, the master terminal candidate acts as a new master terminal in accordance with the priorities, and transmits a notifying signal. Thereby, a time period during which no master terminal exists is shortened, and a terminal which is to participate in the network can immediately start communications with a master terminal (for example, refer to JP-A 2005-6327 (KOKAI)).

However, while a master terminal is receiving a signal, it is difficult for the master terminal to transmit a notifying signal for participating in the network to slave terminals. To transmit a signal in a frequency band in which the master terminal is receiving a signal, it is necessary to provide circuits such as a tunable filter and an echo canceller to prevent the signal transmitted by the master terminal from entering a receiver of the master terminal. These circuits are required to achieve very high performance, and thus consume much power and have large sizes. If the master terminal stops transmitting a notifying signal during reception operation, a terminal which is to newly participate in the network cannot receive a notifying signal, and starts operation as a new master terminal. Therefore, when the network operates under heavy load conditions and a receiving operation time of the master terminal is long, there is the possibility that many master terminals undesirably coexist in the network and system throughput of the network badly deteriorates.

### BRIEF SUMMARY OF THE INVENTION

In accordance with a first aspect of the invention, there is provided a radio communication system, comprising:

a master radio communication terminal including: a first transmitting unit configured to transmit a beacon; a second transmitting unit configured to transmit a first notifying signal which includes information of a frequency of the beacon and a transmission timing of the beacon; a measuring unit configured to measure a reception power of a signal transmitted by each of a plurality of slave radio communication terminals; a selecting unit configured to select a notifying radio communication terminal, which is to transmit a second notifying signal, from the slave radio communication terminals based on the reception power, the second notifying signal including the same information of the frequency of the beacon and the transmission timing of the beacon as the information included in the first notifying signal; and a third transmitting unit configured to transmit, to the notifying radio communication terminal, notifying instruction information including an instruction to transmit the second notifying signal, and

at least one slave radio communication terminal of the slave radio communication terminals including: a first receiving unit configured to receive the notifying instruction information; a fourth transmitting unit configured to transmit the second notifying signal to the other slave radio communication terminals when the slave radio communication terminal receives the notifying instruction information; a second receiving unit configured to receive at least one of the first notifying signal and the second notifying signal; and a third receiving unit configured to receive the beacon based on the information included in one of the received first notifying signal and the received second notifying signal.

In accordance with a second aspect of the invention, there is provided a radio communication terminal, comprising: a first transmitting unit configured to transmit a beacon; a second transmitting unit configured to transmit a first notifying signal which includes information of a frequency of the beacon and a transmission timing of the beacon; a measuring unit configured to measure a reception power of a signal transmitted by each of a plurality of slave radio communication terminals; a selecting unit configured to select a notifying radio communication terminal, which is to transmit a second notifying signal, from the slave radio communication terminals based on the reception power, the second notifying signal including the same information of the frequency of the beacon and the transmission timing of the beacon as the information included in the first notifying signal; and a third transmitting unit configured to transmit, to the notifying radio communication terminal, notifying instruction information including an instruction to transmit the second notifying signal.

### BRIEF DESCRIPTION OF THE SEVERAL VIEWS OF THE DRAWING

FIG. 1 is a diagram illustrating an example of a system configuration according to an embodiment.

FIG. 2 is a conceptual diagram of a notifying signal and a beacon transmitted from a master terminal.

FIG. 3 is a diagram illustrating an example of the notifying signal.

FIG. 4 is a diagram illustrating the relationship between a notifying signal transmitted from the master terminal and notifying signals transmitted from notifying-signal transmitting terminals.

FIG. 5 is a diagram illustrating the relationship between a notifying signal transmitted from the master terminal and notifying signals transmitted from notifying-signal transmitting terminals.

FIG. 6 is a diagram illustrating a sequence of determining a notifying-signal transmitting terminal when a slave terminal participates in a network.

FIG. 7 is a diagram illustrating a sequence of periodically selecting a notifying-signal transmitting terminal from slave terminals.

FIG. 8 is a block diagram of a radio communication terminal according to the embodiment.

FIG. 9 is a block diagram of a notifying-signal reception processing section shown in FIG. 8.

FIG. 10 is a diagram illustrating an example of contents of a database which the master terminal has.

FIG. 11 is a flowchart of updating the value of the database and determining notifying-signal transmitting terminals.

FIG. 12 is a diagram illustrating an example of a terminal arrangement.

FIG. 13 is a diagram illustrating another example of contents of the database which the master terminal has.

FIG. 14 is a block diagram of another radio communication terminal according to the embodiment, which is different from that of FIG. 8.

FIG. 15 is a diagram illustrating an example of contents of a database which the master terminal of FIG. 14 has.

FIG. 16 is a flowchart of updating a reception power, grouping, and selecting notifying-signal transmitting terminals by the master terminal of FIG. 14.

FIG. 17 is a diagram illustrating an example of a terminal arrangement.

FIG. 18 is a diagram illustrating an example of an antenna pattern.

FIG. 19 is a diagram illustrating another example of an antenna pattern.

FIG. 20 is a diagram illustrating another example of an antenna pattern.

FIG. 21 is a diagram illustrating another example of an antenna pattern.

### DETAILED DESCRIPTION OF THE INVENTION

A radio communication terminal and a radio communication system according to an embodiment are explained below with reference to drawings. The radio communication terminal is sometimes referred to as “terminal”.

According to the radio communication terminal and the radio communication system of the embodiment, system throughput of the network is improved.

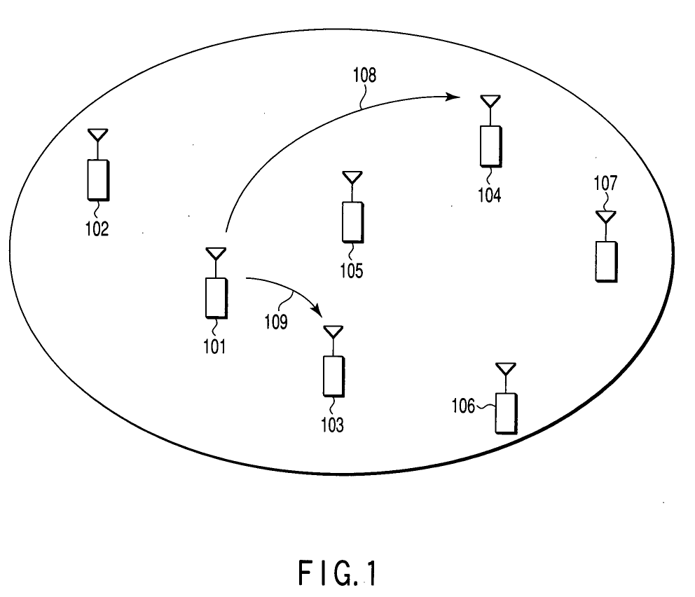

FIG. 1 illustrates an example of a system configuration of the present embodiment. Terminals 101 to 107 form one network (hereinafter also referred to as “system”), and can perform mutual data communications by using signals of a communication frequency band (hereinafter referred to as “main band”). In this state, the terminal 101 operates as a master terminal. The master terminal transmits notifying signals and beacons for terminals which newly participate in the network. Terminals in the network transmit data communication signals at respective frequencies and time slots assigned by the master terminal.

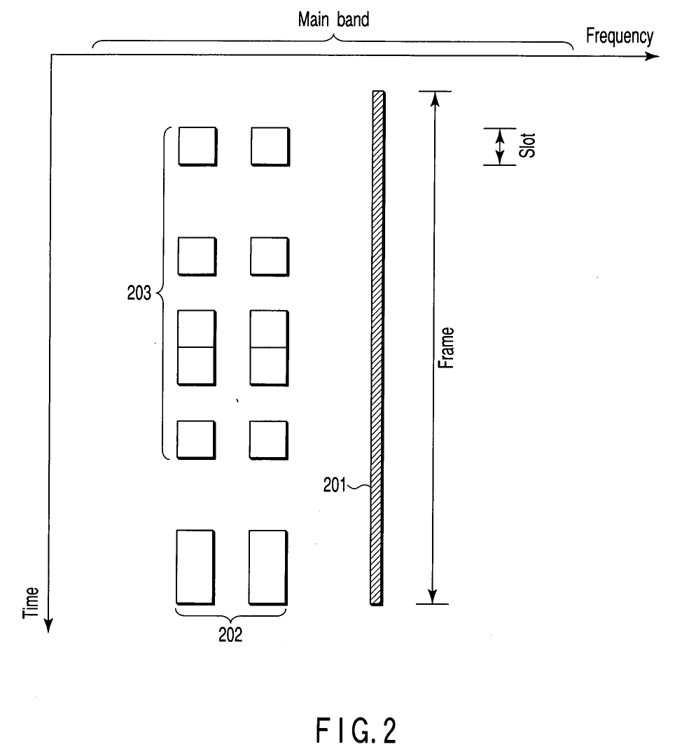

FIG. 2 is a conceptual diagram of a notifying signal and a beacon transmitted from the master terminal. A notifying signal 201 is a signal which a terminal newly participating in the network can demodulate by receiving the signal for a relatively long time (for example, tens of frames: 1 frame is 4 ms). The notifying signal 201 includes information about the frequency and timing of a beacon 202 transmitted from the master terminal. The beacon transmitted from the master terminal includes information specific to the network. Terminals which are to participate in the network send a request of participating in the network to the master terminal, by using the specific information. A beacon is transmitted from the master terminal once in a frame. The master terminal 101 and the slave terminals 102 to 107 perform data communications 203 by using frequencies or times different from those of the notifying signal 201 and the beacon 202. The data communications 203 are used for communications in the same network.

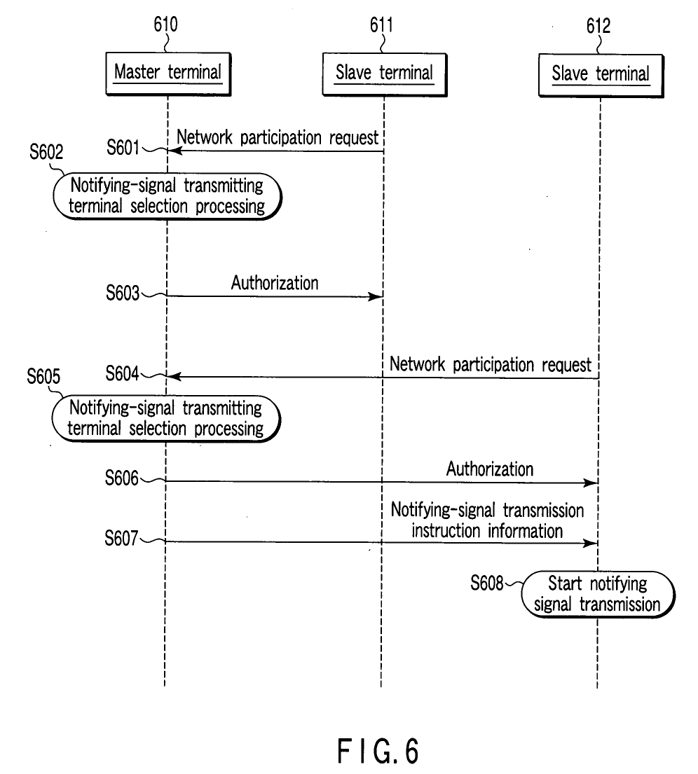

The master terminal 101 selects notifying-signal transmitting terminals from the slave terminals in the network. The selecting method is explained later with reference to FIGS. 6, 7 and 11. Selection may be periodically performed, or may be performed when a new terminal participates in the network. In this case, suppose that the master terminal 101 selects the slave terminals 103 and 104 as notifying-signal transmitting terminals. The master terminal 101 notifies the slave terminals 103 and 104, which have been selected as notifying-signal transmitting terminals, of notifying-signal transmission instruction information 108 and 109. The notifying-signal transmission instruction information includes information necessary for the notified slave terminals to transmit a notifying signal. In this case, suppose that the notifying-signal transmission instruction information includes IDs of terminals to be notified, timing and cycles of transmitting a notifying signal, and a length of time during which a notifying signal is to be transmitted. Examples of other information items to be included are a frequency band at which the notifying-signal transmitting terminals transmit a notifying signal, a frequency hopping pattern, and a spreading code. The slave terminals 103 and 104 that have received the notifying-signal transmission instruction information 108 and 109 serve as notifying-signal transmitting terminals, and start transmission of notifying signals in accordance with the instruction information. When the notifying-signal transmitting terminals are to be changed, the master terminal transmits notifying-signal stop instruction information, which returns the notifying-signal transmitting terminal to a normal slave terminal, to the notifying-signal transmitting terminals, in the same manner as the notifying-signal transmission instruction information.

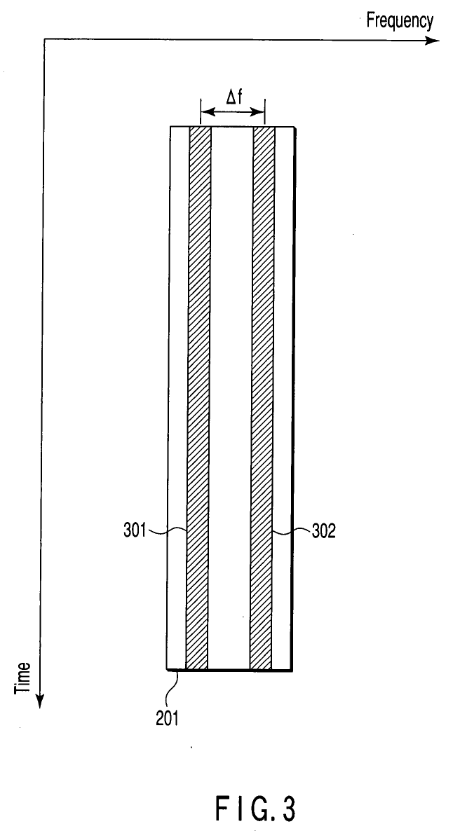

FIG. 3 illustrates a specific example of a notifying signal. The notifying signal 201 shown in FIG. 3 indicates the notifying signal 201 of FIG. 2. The notifying signal 201 includes two narrow-band signals 301 and 302. The narrow-band signals 301 and 302 are, for example, ASK (Amplitude Shift Keying) signals, which are the same base band signals simultaneously transmitted at two frequency bands distant from each other by frequency Δf. When PSK (Phase Shift Keying) is used, the signals 301 and 302 are transmitted by using differential phase keying in which information is held by difference in phase between the two signals. The value Δf is a value specific to the system, and known to the terminals in the network. The slave terminals receive the notifying signal by correlating the narrow-band signals 301 and 302.

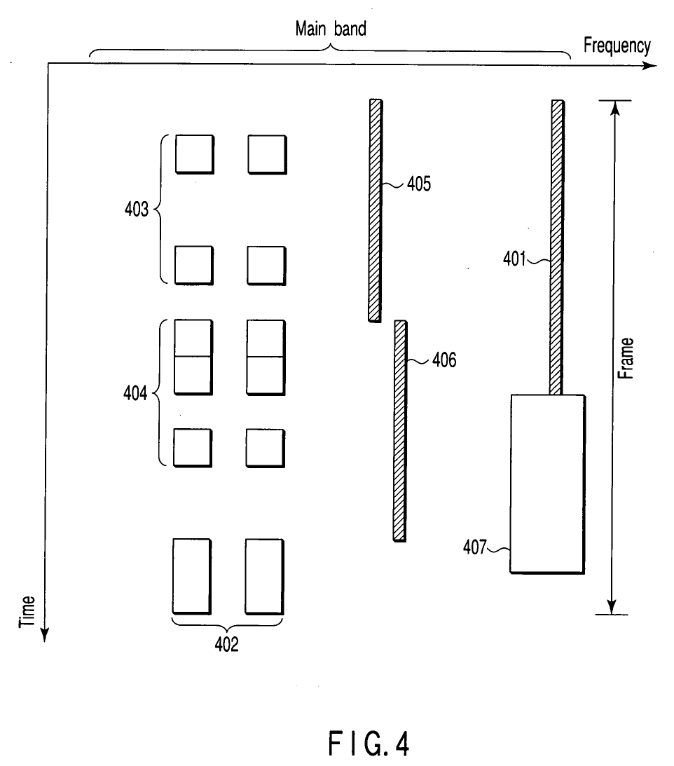

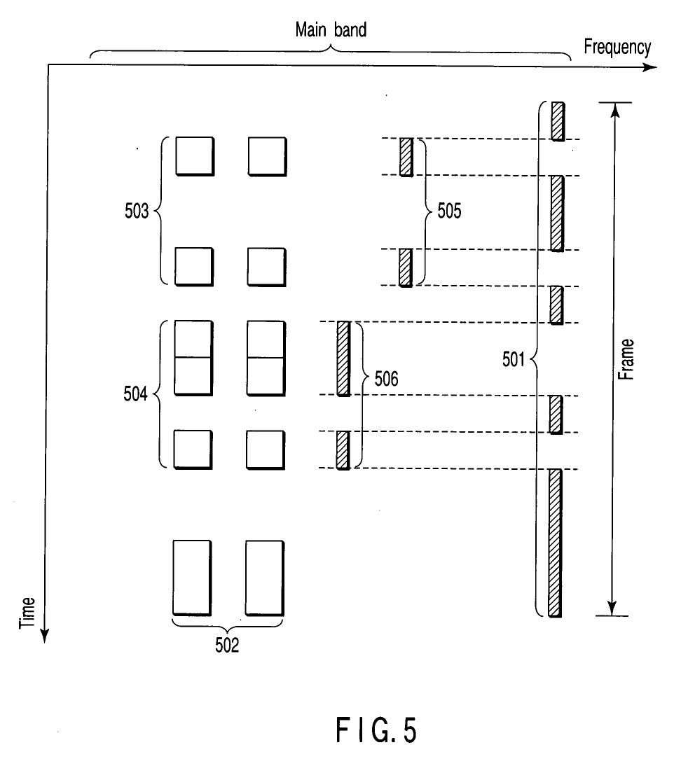

FIGS. 4 and 5 illustrate the relationship between a notifying signal transmitted by the master terminal and notifying signals transmitted by the notifying-signal transmitting terminals.

In FIG. 4, a notifying signal 401 of the master terminal 101 and notifying signals 405 and 406 of the notifying-signal transmitting terminals 103 and 104 are simultaneously transmitted at different frequencies. During the transmission, the notifying-signal transmitting terminal 103 transmitting the notifying signal 405 cannot receive a data communication signal 403 due to interference by the notifying signal 405. In the same manner, the notifying-signal transmitting terminal 104 transmitting the notifying signal 406 has much difficulty in receiving a data communication signal 404. Therefore, it is necessary to allocate slots to prevent one terminal from simultaneously performing transmission and reception.

The notifying signals 401, 405 and 406 notify, during tens of frames, the terminals of the frequency and timing of the beacon 402. During the notification, even when an interference signal 407 occurs and the master terminal 101 has to stop the notifying signal 401, transmission of the notifying signal 406 by the notifying-signal transmitting terminal 104 is continued. Specifically, even when it is hard for slave terminals to receive the notifying signal from the master terminal 101, the slave terminals can receive a notifying signal from the notifying-signal transmitting terminal 104. Therefore, a terminal which is to newly participate in the network can receive the beacon 402, without starting reception of a notifying signal again. When the terminal 101 detects occurrence of the interference signal 407, the terminal 101 stops transmission (transmission of the notifying signal 401) at the frequency band, performs carrier sensing in the main band, and thereafter starts transmission of a notifying signal again in a band where no interference signals exist. Besides signal interference, there are cases where it is difficult for slave terminals to receive a notifying signal from the master terminal due to the position of the master terminal. In consideration of these cases, the notifying-signal transmitting terminal 104 is desirably located in a position distant from the master terminal.

In FIG. 5, a notifying signal 501 of the master terminal 101 and notifying signals 505 and 506 of the notifying-signal transmitting terminals 103 and 104 are transmitted in a time-division method. Data communication signals 503 and 504 are transmitted by slave terminals and received by the master terminal 101. In this example, suppose that the data communication signals 503 and 504 are transmitted by the notifying-signal transmitting terminals 103 and 104. In this case, if the master terminal 101 is transmitting the notifying signal 501 when receiving the data communication signals 503 and 504, the notifying signal transmitted by the master terminal 101 comes close to a receiver of the master terminal 101 and causes interference, and hinders reception of the signals. Therefore, the master terminal 101 does not transmit a notifying signal during reception operation, but instructs the selected notifying-signal transmitting terminals 103 and 104 to transmit a notifying signal while the master terminal is in the reception operation. By sending such instructions from the master terminal 101, the master terminal 101 and the notifying-signal transmitting terminals 103 and 104 transmit notifying signals in a time-division method.

The notifying signals 501, 505 and 506 notify, during tens of frames, the terminals of frequency and timing of the beacon 502. Although the notifying signal 501 of the master terminal is transmitted at a frequency different from those of the notifying signals 505 and 506 of the notifying-signal transmitting terminals in FIG. 5, they may be transmitted at the same frequency. During the notification, even when the master terminal has to stop transmission of a notifying signal while receiving the data communication signals 503 and 504, the notifying-signal transmitting terminals continue to transmit notifying signals in a time-division method. Therefore, a terminal which newly participates in the network can receive the beacon 502, without starting reception of a notifying signal again. In consideration of these cases, the notifying-signal transmitting terminal 104 is desirably located at a position distant from the master terminal.

FIGS. 4 and 5 illustrate examples of transmitting notifying signals which terminals can receive without knowing a frequency band at which the notifying signals are transmitted. In addition, there may be cases of transmitting notifying signals which terminals cannot receive without knowing a frequency band at which the notifying signals are transmitted. In the latter cases, even when a notifying signal transmitted by the master terminal is stopped, the notifying-signal transmitting terminals transmit notifying signals at the same frequency band as that of the notifying signal transmitted by the master terminal, and thereby terminals which are to newly participate in the network can receive a notifying signal. However, in this case, terminals which are to newly participate in the network are required to know the frequency band of notifying signals transmitted by the master terminal. Such notifying signals which terminals cannot receive without knowing its frequency may coexist with notifying signals which terminals can receive without knowing its frequency in the network. Further, the notifying signals explained with reference to FIGS. 4 and 5 may be applied to either of the above notifying signals.

FIG. 6 is a diagram illustrating a sequence performed when the master terminal determines whether slave terminals which newly participate in the network serve as a notifying-signal transmitting terminal or not. Suppose that terminals 611 and 612 which have not yet participated in the network of the master terminal 610 have received a notifying signal transmitted by the master terminal or the notifying-signal transmitting terminal and a beacon transmitted by the master terminal, and have obtained information of the network. When a demand for participation in the network, that is, a demand for channel assignment for data communication occurs in the slave terminal 611, the slave terminal 611 sends a network participation request to the master terminal 610 (Step S601). The master terminal which has received the network participation request performs notifying-signal transmitting terminal selection processing by using a signal power or the like (Step S602). In the notifying-signal transmitting terminal selection processing, the master terminal 610 measures the signal power of the network participation request signal, estimates the distance from the slave terminal based on the magnitude of the signal power, and selects a slave terminal located in a desired position based on the processing result. The notifying-signal transmitting terminal selection processing is explained later with reference to FIG. 11. FIG. 6 illustrates an example where the terminal 611 is not designated as the notifying-signal transmitting terminal. In this case, the master terminal only transmits an answer to the network participation request. In this example, the master terminal 610 transmits a notice of authorization to participate in the network to the slave terminal 611 (Step S603).

Next, suppose that a demand for participation in the network occurs in the slave terminal 612, and the slave terminal 612 sends a network participation request to the master terminal 610 (Step S604). In this case, the master terminal 610 performs notifying-signal transmitting terminal selection processing, in the same manner as above (Step S605). In the processing, if the master terminal 610 determines to select the slave terminal 612 as the notifying-signal transmitting terminal, the master terminal 610 sends, to the slave terminal 612, a notice of authorization to participate in the network (step S606) together with notifying-signal transmission instruction information (Step S607).

The notifying-signal transmission instruction information may include information such as information to be superposed on the notifying signal, the frequency band of the notifying signal, the spreading code, the beam direction, and the transmission power, as well as the timing information of the notifying signal to be transmitted by the slave terminal 612. The timing when the master terminal 610 performs reception may be designated as the notifying-signal transmitting timing, such that the slave terminal 612 transmits a notifying signal while the master terminal 610 is receiving a signal. Further, the timing may be designated such that the master terminal 610 transmits a notifying signal in a time-division method with other notifying-signal transmitting terminals, in consideration of the cases where the master terminal 610 stops transmission of a notifying signal due to occurrence of an interference signal or the like. In the case of designating the frequency band, it is desirable to designate a band having a frequency which is uncorrelated with the frequency band of the notifying signal transmitted by the master terminals 610. Designating such a frequency band reduces the possibility that the notifying-signal transmitting terminal cannot transmit a notifying signal, either, when an interference signal occurs. In the case of designating the beam direction, directing the beam toward the center of the network or toward the master terminal prevents terminals, which the beacon of the master terminal 610 does not reach, from receiving notifying signals. The notifying-signal transmission instruction information is transmitted from the master terminals 610 with a beacon or a data communication signal.

The terminal 612 which has received notifying-signal transmission instruction information performs notifying-signal transmission start processing (Step S608), in accordance with the contents of the notifying-signal transmission instruction information. If the notifying-signal transmission instruction information does not include a specific instruction as to the frequency band for transmitting a notifying signal, the slave terminal 612 performs a carrier sensing in the main band, and transmits a notifying signal in a band where no interference signals exist. Like the notifying signal transmitted by the master terminal, the notifying signal transmitted by the slave terminal 612 also includes information items necessary for receiving a beacon transmitted by the master terminal.

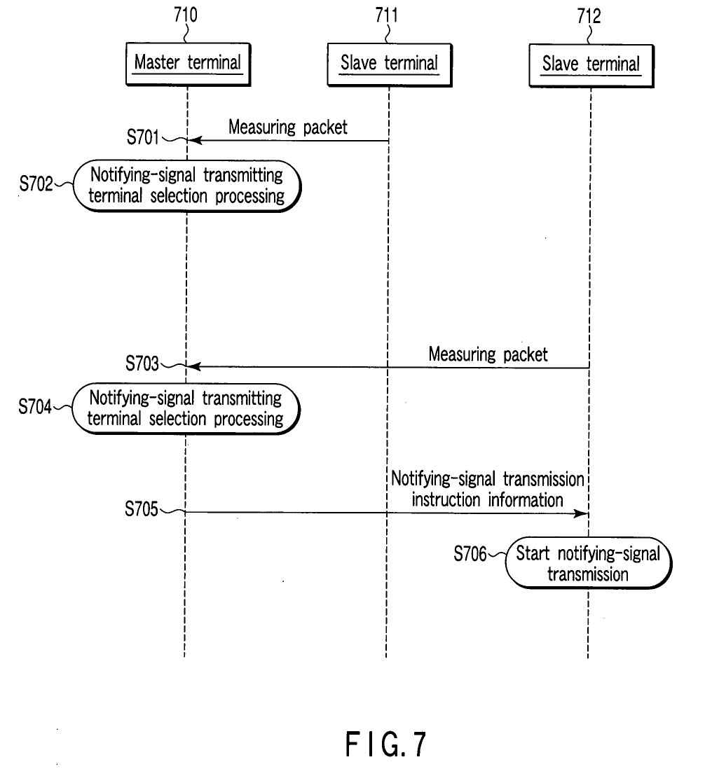

FIG. 7 is a diagram of a sequence performed when the master terminal periodically selects a notifying-signal transmitting terminal from slave terminals. Suppose that slave terminals 711 and 712 have already participated in the network of a master terminal 710, and channels for data communications have been assigned to the slave terminals 711 and 712. The slave terminals 711 and 712 transmit measuring packets for the master terminal's periodically estimating the signal powers and the DoA (direction of arrival) of the signals transmitted from the slave terminals (Steps. S701 and S703). A known signal is desirably used as the measuring packets, such that the power thereof is easily measured. Further, if a narrow-band signal is transmitted as the measuring packets, the signal power may be badly lowered due to frequency-selective fading. Therefore, a broad-band signal is desirably used as the measuring packets, or a plurality of narrow-band signals may be transmitted as the measuring packets by using two or more frequency bands. The master terminal 710 selects a desired slave terminal by estimating, for example, the reception power and the DoA of the known signal.

The master terminal 710 which has received a measuring packet from the slave terminal 711 performs notifying-signal transmitting terminal selection processing (Step S702), and determines whether the slave terminal 711 should be selected as a notifying-signal transmitting terminal. In this example, the master terminal 710 determines not to select the slave terminal 711 as the notifying-signal transmitting terminal, and takes no further actions. The master terminal 710 which has received the measuring packet from the slave terminal 712 performs notifying-signal transmitting terminal selection processing in the same manner (Step S704). Then, suppose that the master terminal 710 determines to select the slave terminal 712 as a notifying signal transmitting terminal. In this case, the master terminal 710 transmits notifying-signal transmission instruction information to the slave terminal 712 (Step S705), and the slave terminal 712 which has received the notifying signal transmission instruction information performs notifying-signal transmission start processing in accordance with the instruction (step S706). The notifying signal transmission instruction information also includes information as to whether notifying signals are simultaneously transmitted at different frequencies as illustrated in FIG. 4, or notifying signals are transmitted in a time-division method as illustrated in FIG. 5.

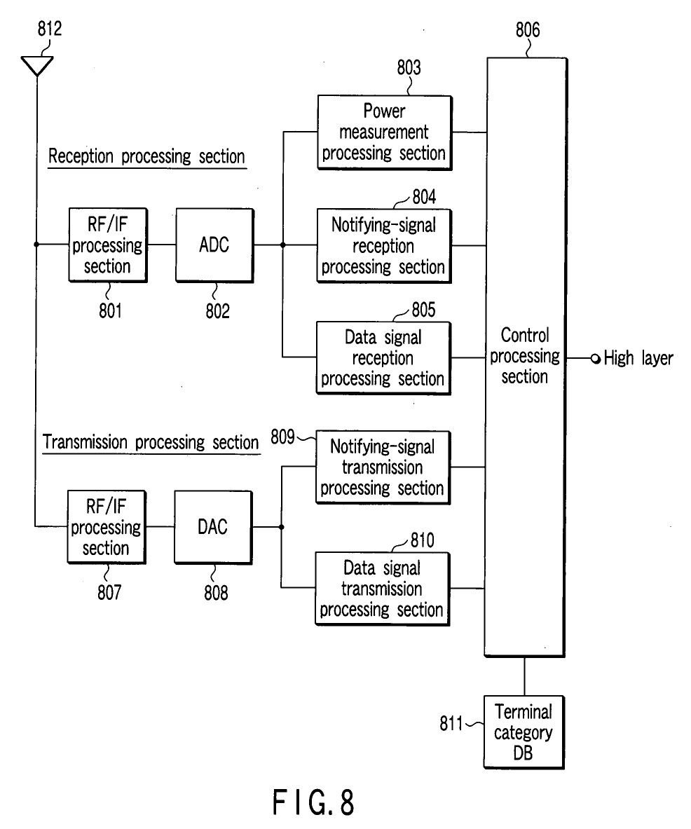

FIG. 8 is a block diagram of an example of a radio communication terminal.

First, sections of the radio communication terminal are explained in accordance with a reception operation. A radio frequency signal received by an antenna 812 is converted into a base band signal having a frequency bandwidth of the main band by an RF/IF processing section 801. The base band signal is converted into a digital signal by an ADC 802.

A power measurement processing section 803 is used for measuring the signal powers of signals from slave terminals, when the terminal operates as a master terminal. The powers of signals received from slave terminals are calculated by using, for example, RSSI (received-signal intensity) of the signal band. The timing of measurement is notified by a control processing section 806 when a network participation request is received from a slave terminal or a power measuring packet is received. Suppose that power measuring packets are periodically transmitted from slave terminals, and the control processing section 806 knows the period of transmission. The measured signal power is stored in a terminal category DB (DB: database) 811 through the control processing section 806.

A notifying-signal reception processing section 804 is used for receiving a notifying signal from the master terminal when the terminal operates as a slave terminal. The control section 806 is notified of data of a notifying signal obtained by the notifying-signal reception processing section 804, that is, data necessary for receiving a beacon from the master terminal, such as the frequency and timing of the beacon.

A data signal reception processing section 805 is used for receiving the notifying-signal transmission instruction information, when receiving transmission data from the master terminal or the slave terminals and receiving a beacon from the master terminal. When a beacon is received, the data signal reception processing section 805 receives information necessary for receiving a beacon from the control processing section 806. After receiving a beacon, the data signal reception processing section 805 notifies the control processing section 806 of information necessary for participating in the network and slot assignment information for data communications, which are included in the beacon. When transmission data is received from the master terminal or the slave terminal, the data signal reception processing section 805 receives the slot assignment information from the control processing section 806, and performs reception in accordance with the information.

Next, sections of the radio communication terminal are explained in accordance with a transmission operation.

A notifying-signal transmission processing section 809 prepares a notifying signal and transmits the notifying signal to a DAC 808, when the terminal operates as the master terminal. Beacon information to be superposed on the notifying signal is received from the control processing section 806.

A data signal transmission processing section 810 receives data from the control processing section 806, and performs data transmission to the master terminal or slave terminals, and beacon transmission. Signals output from the notifying-signal transmission processing section 809 and the data signal transmission processing section 810 are converted into analogue signals by the DAC 808, further converted into radio frequency signals by an RF/IF processing section 807, and then output from the antenna 812.

The control processing section 806 performs exchange of data with the high layer, and notifying-signal transmitting terminal determination processing, in addition to the above processing.

The terminal category database 811 stores information of the slave terminals in the network, when the radio communication terminal operates as the master terminal.

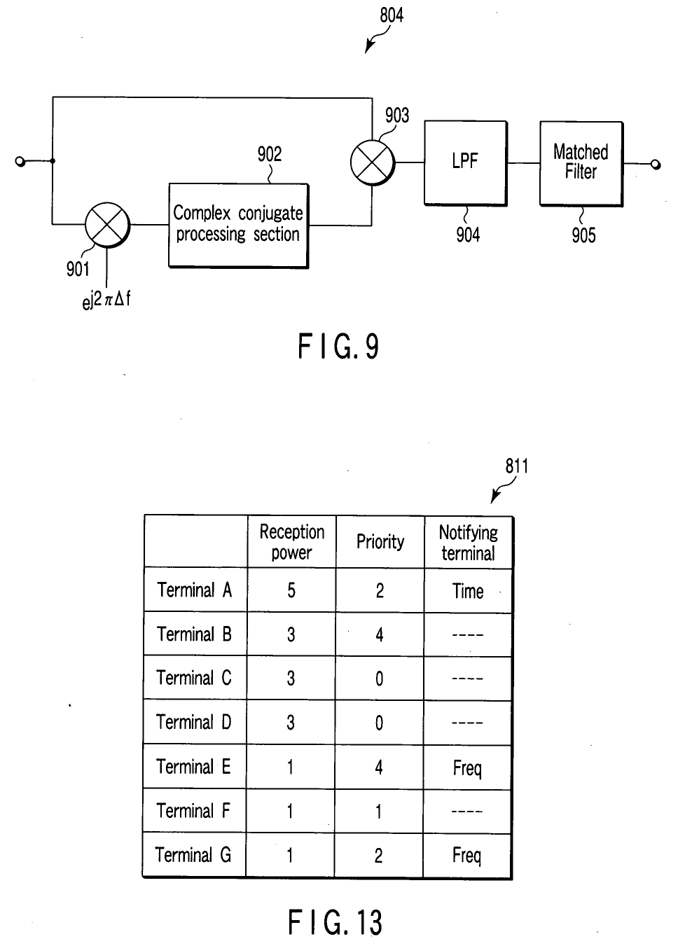

FIG. 9 is a block diagram of an example of the notifying-signal reception processing section 804.

A signal input from the ADC 802 is frequency-converted by Δf in a complex multiplication processing section 901. Thereafter, the signal is complex-conjugated in a complex conjugate processing section 902, and a complex multiplication section 903 performs complex multiplication of the input signal from the ADC 802 and the complex-conjugated signal. Thereby, a phase differential vector of the two narrow-band signals 301 and 302 shown in FIG. 3 is obtained. The vector is input to an LPF (Low Pass Filter) 904 adjusted to the symbol band of the notifying signal, and thereby a reception result of a signal transmitted from the master terminal is obtained. The result is subjected to matched filtering by a matched filter 905, and thereby synchronization is established, and information of the notifying signal is obtained.

According to the above structure, slave terminals can receive a notifying signal, without knowing in which frequency band in the main band the notifying signal exists. Further, even when a plurality of terminals transmit notifying signals, the slave terminals can receive them without special processing, as long as the notifying signals have the same contents and the same Δf value. Therefore, the notifying-signal transmitting terminal can transmit a notifying signal at a desired frequency.

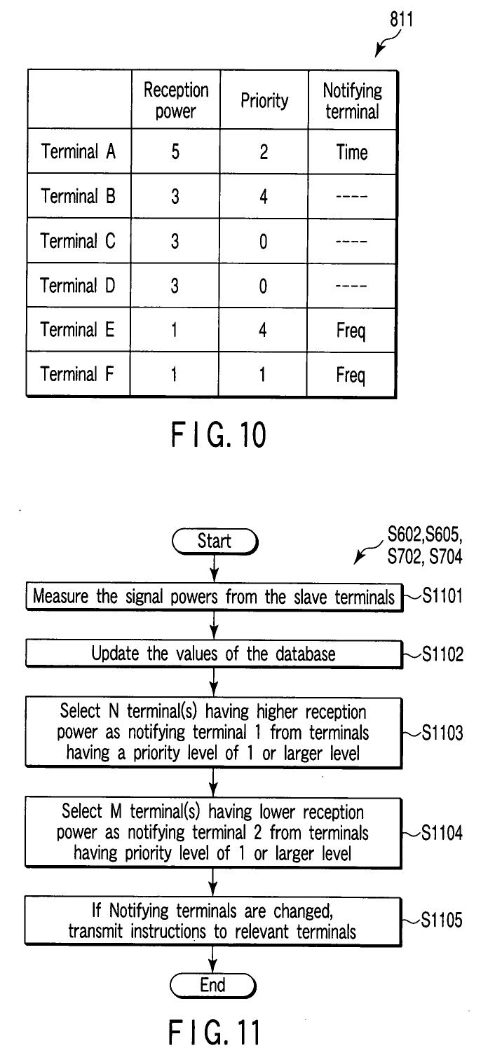

FIG. 10 illustrates an example of information of the database held by the master terminal.

The master terminal has a database (terminal category database 811) storing information of slave terminals in the network. The terminal category database 811 stores information of reception power from the slave terminals, priorities of the slave terminals on serving as a notifying-signal transmitting terminal, and the notifying-signal transmitting terminal type.

The reception powers are ranked according to the intensity thereof. In this example, the reception powers are grouped under levels 1 to 5, and the terminals of level 5 have the strongest power. If the system is a system where terminals perform transmission power control, it is necessary to perform normalization using the transmission power of slave terminals.

The priority is an indicator indicating whether a slave terminal is suitable as a notifying-signal transmitting terminal. The priority is determined by the master terminal using a certain standard, or the slave terminals notify the master terminal of the priorities thereof. In this example, slave terminals are grouped under six levels, that is, Levels 0 to 5. Level 0 indicates terminals which cannot transmit a notifying signal, and level 5 indicates terminals which are most suitable as a notifying-signal transmitting terminal. An example of a slave terminal which is most suitable as a notifying-signal transmitting terminal is a terminal having a long power-supply duration. The priority depends on the time for which the terminal can continuously supply the power. For example, terminals which are connected to an AC power source and can be used without checking power consumption have a higher priority. Conversely, terminals which operate on batteries and have a little battery remaining amount gain a lower priority. Further, as a result of interference detection in the main band performed by the terminals, terminals suffering frequent interference gain a lower priority, and terminals in which interference is not detected for a long time in a frequency band in the main band gain a higher priority.

The notifying-signal transmission terminal type indicates how the notifying-signal transmitting terminal transmits a notifying signal. For example, terminals registered as “Freq” transmit a notifying signal simultaneously with a notifying signal of the master terminal, by using a frequency different from that of the master terminal as shown in FIG. 4, in preparation for the cases where the master terminal cannot transmit notifying signals due to interference signals. Terminals registered as “Time” transmit a notifying signal in a time-division method with a notifying signal of the master terminal as shown in FIG. 5, in consideration of the cases where the master terminal cannot transmit a notifying signal during reception operation.

FIG. 11 illustrates an example of a flow where the master terminal updates the value of the database and determines notifying-signal transmitting terminals. This operation is performed with steps S602, S605, S702, and S704.

First, the master terminal measures the signal powers from the slave terminals (Step S1101). The signal power measurement may be performed by using network participation requests from the slave terminals, or using power measuring packets. Next, the master terminal updates the values of the terminal category database 811 in accordance with the measured signal powers (Step S1102). Using the update result, the master terminal selects N terminal(s) (N is an integer not smaller than 1) having a high reception power as notifying terminal 1 from terminals having a priority level 1 or larger level (Step S1103). Specifically, the master terminal selects at least one terminal close to the master terminal. The notifying terminal 1 is a terminal which transmits a notifying signal in a time-division method with a notifying signal of the master terminal, in consideration of the cases where the master terminal cannot transmit a notifying signal during a reception operation. If terminals exceeding N exist in the category of the same reception power, a terminal having a higher priority is selected.

Further, using the update result, the master terminal selects M terminal(s) (M is an integer not smaller than 1) having a lower reception power as notifying terminal 2 from terminals having a priority level 1 or larger level (Step S1104). Specifically, the master terminal selects at least one terminal distant from the master terminal. The notifying terminal 2 is a terminal which transmits a notifying signal simultaneously with a notifying signal of the master terminal by using a frequency different from that of the master terminal, in preparation for the cases where the master terminal cannot transmit a notifying signal due to interference signals. If terminals exceeding M exist in the category of the same reception power, a terminal having a higher priority is selected. Lastly, when there is any change in the section of the notifying terminal in the database, the master terminal notifies the relevant notifying terminals of the notifying-signal transmission instruction information or notifying-signal stop instruction information (Step S1105).

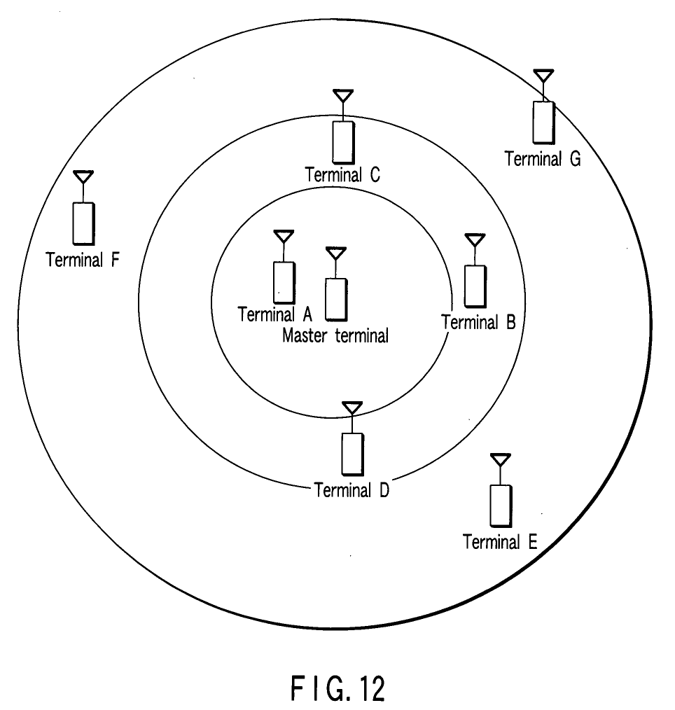

It is specifically explained below how the database and the notifying-signal transmitting terminals are changed in the terminal arrangement illustrated in FIG. 12.

Suppose that the master terminal has the terminal category database 811 illustrated in FIG. 10, and terminals A to F operate as slave terminals. Further, suppose that N is 1 and M is 2. When the terminal G sends a network participation request to the master terminal, the master terminal measures the reception power of the terminal G and determines the category of the reception power by using the network participation request, and determines the category of the priority of the terminal G by using the terminal conditions included in the network participation request. By using the obtained information, the master terminal updates the terminal category database 811. Further, the master terminal starts the processing of determining the notifying-signal transmitting terminals.

As illustrated in FIG. 13, when the signal power of the terminal G is 1 and the priority of the terminal G is 2, the terminal G comes under a category of the lowest reception power, and has a priority higher than that of the terminal F. Therefore, the terminal G is designated as a notifying-signal transmitting terminal (notifying terminal 2, “Freq”), and the terminal F is changed from a notifying-signal transmitting terminal to a normal slave terminal. As a result, the master terminal transmits a notifying-signal stop instruction to the terminal F, and transmits a notifying-signal transmission instruction to the terminal G.

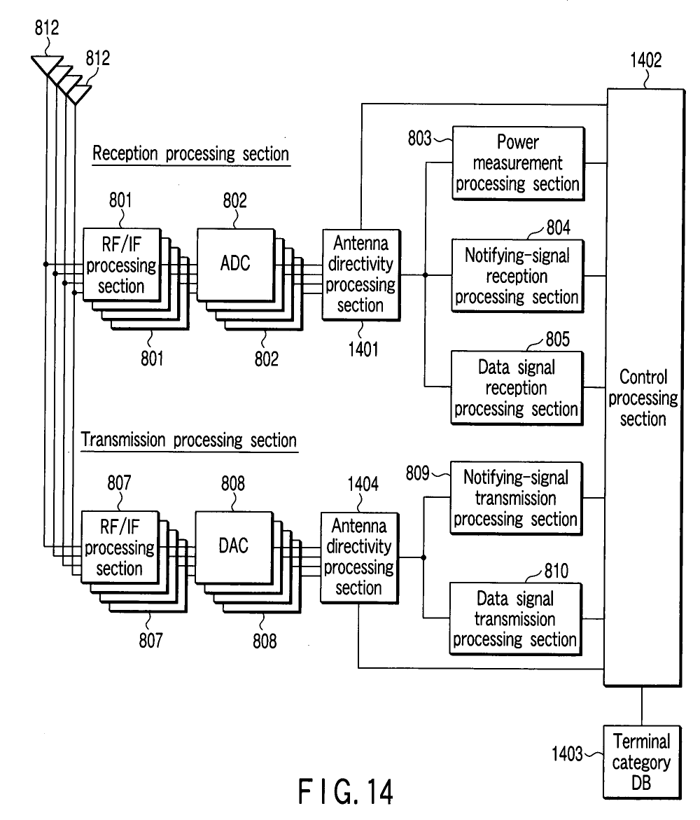

FIG. 14 is a block diagram of another example of the radio communication terminal. Constituent elements which are the same as those already explained above are denoted by the same respective reference numerals, and explanation thereof is omitted.

First, sections are explained in accordance with reception operation. Although four antennas are illustrated in FIG. 14, the number of antennas may be any number which can establish directivities of at least two patterns. As the number of antennas is increased, the number of directivity patterns is also increased and the positions of the terminals are more easily detected. However, increasing the number of antennas incurs a disadvantage such as an increase in size of the radio communication terminal.

Radio frequency signals received by the antenna 812 are converted into base band signals having a frequency bandwidth of the main band by RF/IF processing sections 801. The base band signals are converted into digital signals by the ADCs 802.

An antenna directivity processing section 1401 rotates the phases of the received signals and adds the received signals in accordance with instructions from a control processing section 1402, and thereby outputs a received signal having an antenna directivity in accordance with the instructions. A power measurement processing section 803 is used for measuring signal power from slave terminals when the radio communication terminal operates as the master terminal. The powers of signals received from slave terminals are calculated by using, for example, RSSI of the signal band. The timing of measurement is notified by a control processing section 1402 when a network participation request is received from a slave terminal or a power measuring packet is received. Suppose that power measuring packets are periodically transmitted from slave terminals, and the control processing section 1402 is notified in advance of the period of transmission. The measured signal powers are stored in a terminal category DB 1403 through the control processing section 1402.

A notifying-signal reception processing section 804 is used for receiving a notifying signal from the master terminal when the terminal operates as a slave terminal. The control section 1402 is notified of data of a notifying signal obtained by the notifying-signal reception processing section 804, that is, data necessary for receiving a beacon from the master terminal, such as the frequency and timing of the beacon. When the notifying-signal reception processing section 804 performs notifying-signal reception processing, the antenna directivity processing section 1401 is preferably controlled to be omnidirectional.

A data signal reception processing section 805 is used when receiving transmission data from the master terminal or the slave terminals and receiving a beacon from the master terminal. When a beacon is received, the data signal reception processing section 805 receives information necessary for receiving a beacon from the control processing section 1402. After receiving a beacon, the data signal reception processing section 805 notifies the control processing section 1402 of information necessary for participating in the network and slot assignment information for data communications, which are included in the beacon. When transmission data is received from the master terminal or the slave terminal, the data signal reception processing section 805 receives the slot assignment information from the control processing section 1402, and performs reception in accordance with the information.

Next, sections of the radio communication terminal are explained in accordance with a transmission operation. A notifying-signal transmission processing section 809 prepares a notifying signal and transmits the notifying signal to an antenna directivity processing section 1404, when the terminal operates as the master terminal. Beacon information to be superposed on the notifying signal is received by the notifying-signal transmission processing section 809 from the control processing section 1402. A data signal transmission processing section 810 receives data from the control processing section 1402, and performs data transmission to the master terminal or slave terminals, and beacon transmission. Signals output from the notifying-signal transmission processing section 809 and the data signal transmission processing section 810 are input to the antenna directivity processing section 1404.

The antenna directivity processing section 1404 rotates phases of signals and outputs the signals to DACs 808 corresponding to the respective antennas, in accordance with instructions from the control processing section 1402. For example, in notifying-signal transmission processing, if a notifying signal is transmitted in a time-division method with the notifying signal of the master terminal, it is preferable to perform omnidirectional transmission with no directivity, in consideration of the cases where the master terminal cannot transmit a notifying signal during reception operation. Further, if a notifying signal is transmitted simultaneously with the notifying signal of the master terminal in preparation for the cases where the master terminal cannot transmit a notifying signal due to interference signals, it is preferable to form a beam toward the center of the network or toward the master terminal. Such a structure prevents an unnecessary increase in the size of the network, and improves the throughput of the system. Directivity parameters may be instructed by the master terminal, or determined by the notifying-signal transmitting terminal by estimating the incoming direction of the beacon and recognizing the direction of the master terminal with use of the incoming direction estimate technique. The signals output from the antenna directivity processing section 1404 are converted into analogue signals by the DAC 808, further converted into radio frequency signals by the RF/IF processing sections 807, and then output from the antennas 812.

Although antenna patterns are formed by digital signal processing in the embodiment of FIG. 14, the antenna patterns may be formed by analogue signal processing. Further, antenna patterns may be formed by physically changing the directions of the antennas.

The control processing section 1402 performs exchange of data with the high layer, notifying-signal transmitting terminal determination processing, and determines the antenna directivity, in addition to the above processing. The terminal category database 1403 stores information of the slave terminals in the network, when the radio communication terminal operates as the master terminal.

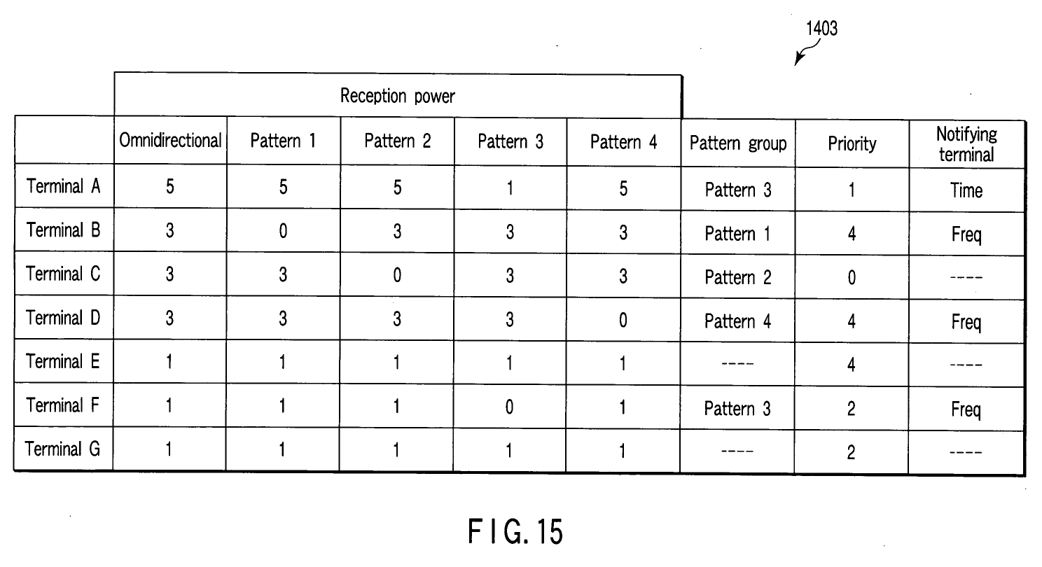

FIG. 15 illustrates an example of information of the database which the master terminal (the configuration of FIG. 14) has.

The master terminal has the terminal category database 1403 storing information of slave terminals in the network. The terminal category database 1403 stores information of reception powers from the slave terminals, priorities of the slave terminals on serving as a notifying-signal transmitting terminal, the type of the notifying-signal transmitting terminal, and classified antenna pattern groups. The reception powers are ranked according to the intensity thereof. The reception powers for the respective antenna patterns are stored for each terminal in the database. In this example, the reception powers are grouped under levels 1 to 5, and the terminals of level 5 have the strongest power. If the system is a system where terminals perform transmission power control, it is necessary to perform normalization using transmission powers of slave terminals. The priority is an indicator indicating whether a slave terminal is suitable as a notifying-signal transmitting terminal. The priority is determined by the master terminal using a certain standard, or the slave terminals notify the master terminal of the priorities thereof. In this example, slave terminals are grouped under six levels, that is, Levels 0 to 5. Level 0 indicates terminals which cannot transmit a notifying signal, and level 5 indicates terminals which are most suitable as a notifying-signal transmitting terminal. An example of a slave terminal which is most suitable as a notifying-signal transmitting terminal is a terminal having a long power supply duration. For example, terminals which are connected to an AC power source and can be used without checking power consumption have a higher priority, and terminals which operate on batteries and have a little battery remaining amount gain a lower priority. Further, as a result of interference detection in the main band performed by the terminals, terminals suffering frequent interference gain a lower priority, and terminals in which interference is not detected for a long time in a frequency band in the main band gain a higher priority. The notifying-signal transmission terminal type indicates how the notifying-signal transmitting terminal transmits a notifying signal. For example, terminals registered as “Freq” transmit a notifying signal simultaneously with a notifying signal of the master terminal, by using a frequency different from that of the master terminal as shown in FIG. 4, in preparation for the cases where the master terminal cannot transmit notifying signals due to interference signals. Terminals registered as “Time” transmit a notifying signal in a time-division method with a notifying signal of the master terminal as shown in FIG. 5, in consideration of the cases where the master terminal cannot transmit a notifying signal during reception operation.

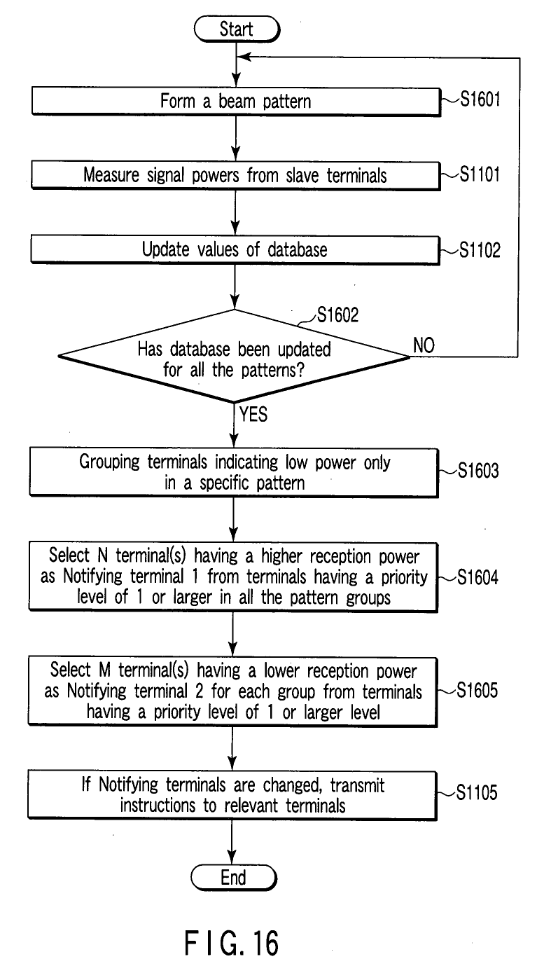

FIG. 16 illustrates a method of updating the reception powers in the database of the master terminal of FIG. 14, a method of antenna grouping, and a method of selecting notifying-signal transmitting terminals. In the present embodiment, suppose that the powers are measured with antenna patterns in which a null is formed in one direction. Steps which are the same as the above explained steps are denoted by the same respective reference numerals, and explanation thereof is omitted.

First, before measuring the signal powers from the slave terminals, the master terminal forms one of the antenna patterns which the master terminal has (Step S1601). If the master terminal measures the signal power from slave terminals by using a network participation request signal, the master terminal forms an antenna pattern when a signal such as a postamble following a network participation request is transmitted, for example. If the master terminal periodically performs measurement, the master terminal forms an antenna pattern when receiving a power-measuring packet transmitted from the slave terminals. After forming an antenna pattern, the master terminal receives signal powers from the slave terminals (Step S1101). The signal power measurement may be performed by using network participation request signals from the slave terminals, or using power-measuring packets. Next, the master terminal updates the terminal category database 1403 by using values of the measured signal powers, in accordance with the antenna pattern (Step S1102). The above steps are performed for all the antenna patterns (Step S1602). For example, in the database of FIG. 15, a loop from the step S1601 to the step S1602 is performed five times.

When measurement of the power is finished for all the antenna patterns (Yes of Step S1602), the master terminal performs grouping of the terminals according to the antenna patterns (Step S1603), by using the database update result. First, the master terminal finds a terminal whose signal power greatly decreases only in a specific antenna pattern. The master terminal determines that the terminal exists in the direction of null in the relevant antenna pattern. In determining whether the signal power greatly decreases, when there is a pattern in which the relevant terminal has a signal power lower by at least 20 dB than an average signal power of the terminal for all the patterns, it is determined that the terminal exists in the direction of the null of the pattern. When a terminal has a similar signal power on average for each of the patterns, the terminal does not belong to any antenna pattern groups. By using the above method, the master terminal classifies all the terminals.

The master terminal selects N terminal(s) having a higher reception power as the notifying terminal 1 from terminals having a priority of level 1 or larger level in all the pattern groups (Step S1604). The notifying terminal 1 is as defined above. Thereafter, the master terminal selects M terminal(s) having a lower reception power as the notifying terminal 2 from terminals having a priority of level 1 or larger level for each of the pattern groups (Step S1605). The notifying terminal 2 is as defined above. Lastly, if there is any change in the notifying terminal section of the database, the master terminal notifies the relevant terminals of notifying-signal transmission instruction information, or notifying-signal stop instruction information (Step S1105). Although the priority levels in the steps S1604 and 1605 are set to level 1 or larger level, they are not limited to level 1, but may be set to desired levels according to necessity.

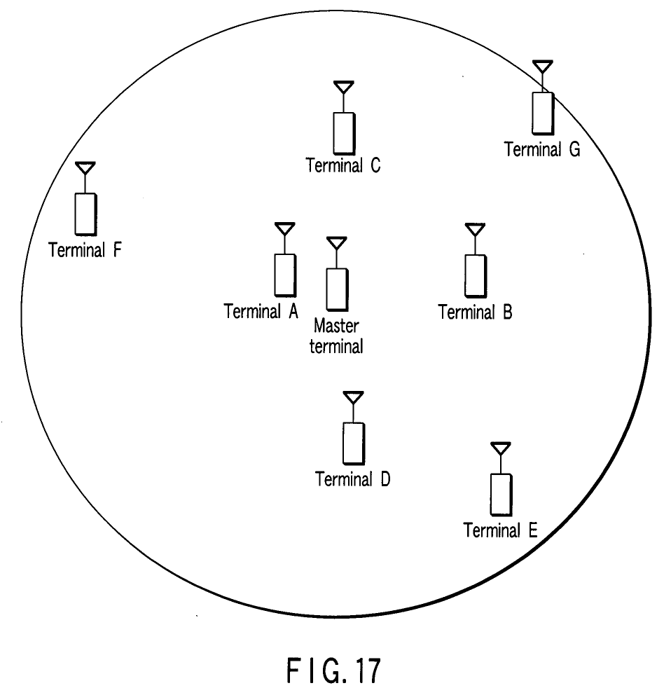

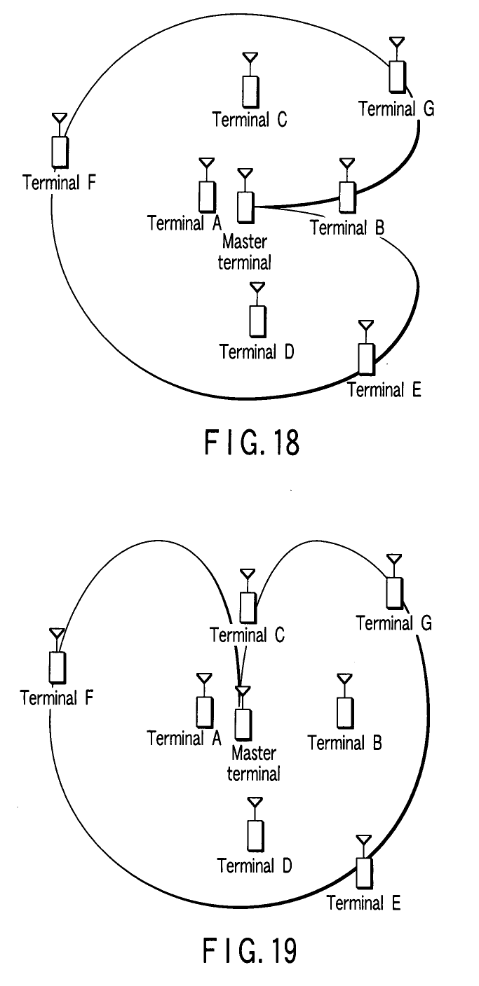

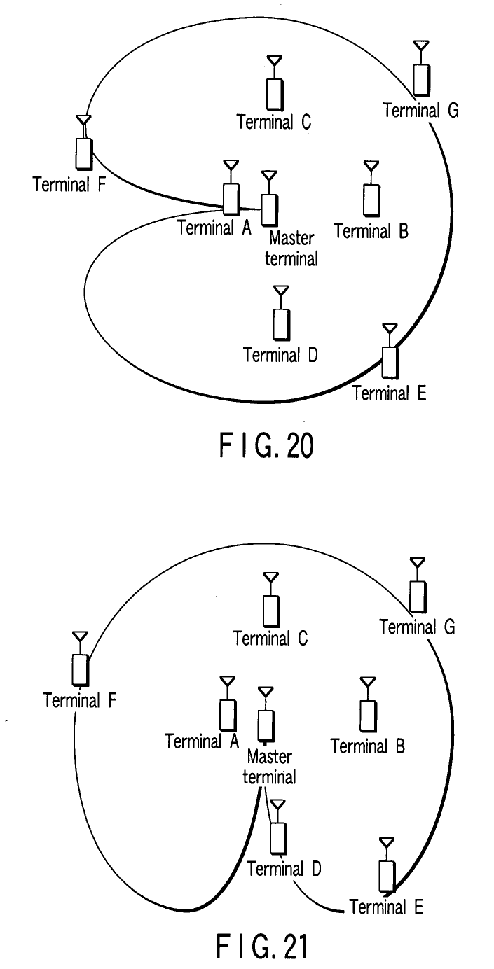

Suppose that the master terminal has the database with the contents illustrated in FIG. 15, and the terminals A to G operate as slave terminals. Further, suppose that M is 1. The master terminal forms several antenna patterns when the terminals transmit power-measuring packets. For example, the master terminal forms an omnidirectional pattern as illustrated by a circle in FIG. 17, and four patterns in which a null is made in one direction as illustrated in FIGS. 18 to 21, that is, Patterns 1 to 4. Each time the antenna patterns are changed, the master terminal measures the reception powers of the terminals by using power-measuring packets from the terminals. When the master terminal receives a power-measuring packet from the terminal B, the measured power of the terminal B greatly decreases only in antenna pattern 1 in which null is made in the direction of the terminal B. In the example of FIG. 15, the reception power of the terminal B is 0 only in pattern 1, although the reception power is 3 in other antenna patterns. Therefore, the master terminal determines that the terminal B exists in the direction of null of the antenna pattern 1, and determines that the pattern group of the terminal B is pattern 1. In the same manner, since the signal power of the terminal C decreases in the antenna pattern 2, the terminal C is classified as pattern group 2. The terminals E and G do not exist in the null direction in any of the antenna patterns in this example, and thus have almost uniform reception power and do not belong to any groups.

After grouping, the master terminal determines the notifying-signal transmitting terminal. In the conditions illustrated in FIG. 15, the terminal B and the terminal D exist alone in the pattern groups 1 and 4, respectively, and thus are selected as the notifying-signal transmitting terminals of the respective groups. Although the terminal C belongs to the pattern group 2, the terminal C has priority level 0 and cannot be selected as the notifying-signal transmitting terminal. Therefore, the terminal C is not selected as the notifying-signal transmitting terminal. Two terminals belong to the pattern group 3. Since M is 1 in this example, only one terminal is selected in the pattern group 3. Since the priority of the terminal F is higher than that of the terminal A, the terminal F is selected as the notifying-signal transmitting terminal of the pattern group 3.

In this example, the positions of the terminals are estimated and the terminals are grouped by using the antenna patterns. However, for example, the following structure may be adopted: terminals are provided with GPS, and notify the master terminal of the position information of the terminals, and the master terminal stores the GPS position information in the database in association with the terminal information. In this case, terminals close to each other may be classified as one group, and a synchronizing signal notifying terminal may be selected from the group.

According to the above embodiment, even when the master terminal is in reception operation and cannot transmit a notifying signal, a terminal with a demand for participation in the network can easily participate in the network by using a notifying signal from the notifying-signal transmitting terminal.

Further, since notifying signals are transmitted from a plurality of terminals by using different frequencies, terminals with a demand for participation in the network can easily participate in the network, by virtue of the antenna diversity effect and frequency diversity effect. Since terminals with a demand for participation in the network can easily participate in the network, an undesirable increase of the master terminals is prevented, and the system throughput of the network is increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication system, comprising:
a master radio communication terminal including:
a first transmitting unit configured to transmit a beacon;
a second transmitting unit configured to transmit a first notifying signal which includes information of a frequency of the beacon and a transmission timing of the beacon;
a measuring unit configured to measure a reception power of a signal transmitted by each of a plurality of slave radio communication terminals;
a selecting unit configured to select a notifying radio communication terminal, which is to transmit a second notifying signal, from the slave radio communication terminals based on the reception power, the second notifying signal including the same information of the frequency of the beacon and the transmission timing of the beacon as the information included in the first notifying signal; and
a third transmitting unit configured to transmit, to the notifying radio communication terminal, notifying instruction information including an instruction to transmit the second notifying signal, and
at least one slave radio communication terminal of the slave radio communication terminals including:
a first receiving unit configured to receive the notifying instruction information;
a fourth transmitting unit configured to transmit the second notifying signal to the other slave radio communication terminals when the slave radio communication terminal receives the notifying instruction information;
a second receiving unit configured to receive at least one of the first notifying signal and the second notifying signal; and
a third receiving unit configured to receive the beacon based on the information included in one of the received first notifying signal and the received second notifying signal.

2. A radio communication terminal, comprising:
a first transmitting unit configured to transmit a beacon;
a second transmitting unit configured to transmit a first notifying signal which includes information of a frequency of the beacon and a transmission timing of the beacon;
a measuring unit configured to measure a reception power of a signal transmitted by each of a plurality of slave radio communication terminals;
a selecting unit configured to select a notifying radio communication terminal, which is to transmit a second notifying signal, from the slave radio communication terminals based on the reception power, the second notifying signal including the same information of the frequency of the beacon and the transmission timing of the beacon as the information included in the first notifying signal; and
a third transmitting unit configured to transmit, to the notifying radio communication terminal, notifying instruction information including an instruction to transmit the second notifying signal.

3. The terminal according to claim 2, further comprising:
a receiving unit configured to receive a data communication signal from the slave radio communication terminals,
wherein the notifying instruction information includes a reception timing at which the radio communication terminal receives the data communication signal, and
the notifying radio communication terminal transmits the second notifying signal based on the reception timing, while the radio communication terminal is receiving the data communication signal.

4. The terminal according to claim 2, wherein
the selecting unit selects two or more slave radio communication terminals from the slave radio communication terminals as notifying radio communication terminals, and
the selected notifying radio communication terminals transmit the second notifying signal in a time-division method.

5. The terminal according to claim 2, wherein
each of the notifying radio communication terminals detects signal interference, and transmits the second notifying signal in a frequency band where no signal interference exists.

6. The terminal according to claim 2, wherein
the notifying instruction information includes a frequency hopping pattern to transmit the second notifying signal in a frequency-hopping method, and
each of the notifying radio communication terminals transmits the second notifying signal by using the frequency hopping pattern.

7. The terminal according to claim 2, further comprising:
a grouping unit configured to group the slave radio communication terminals in accordance with magnitude of the reception power,
wherein the selecting unit selects N slave radio communication terminals (N is an integer not smaller than 1) as notifying radio communication terminals from a group of largest reception power.

8. The terminal according to claim 2, further comprising:
an acquiring unit configured to acquire priority information from each of the slave radio communication terminals, the priority information including at least one of a power supply duration, a battery remaining amount, and a frequency with which a signal interference is detected;
a providing unit configured to provide a higher priority, based on the priority information, to the slave radio communication terminals having a longer power supply duration, a larger battery remaining amount, and a lower signal interference frequency; and
a grouping unit configured to group the slave radio communication terminals in accordance with magnitude of the reception power,
wherein the selecting unit selects N slave radio communication terminals (N is an integer not smaller than 1) having a higher priority as notifying radio communication terminals from a group of largest reception power.

9. A radio communication terminal of a plurality of radio communication terminals communicating with a master radio communication terminal adapted to transmit a first notifying signal, comprising:
a first receiving unit configured to receive, from the master radio communication terminal, notifying instruction information including an instruction to transmit a second notifying signal including the same information of a frequency of a beacon transmitted from the master radio communication terminal and a transmission timing of the beacon as information included in the first notifying signal transmitted from the master radio communication terminal;
a transmitting unit configured to transmit the second notifying signal to other radio communication terminals when the radio communication terminal receives the notifying instruction information;
a second receiving unit configured to receive at least one of the first notifying signal and the second notifying signal; and
a third receiving unit configured to receive the beacon, based on the information included in one of the received first notifying signal and the received second notifying signal.

10. The terminal according to claim 9, wherein
the notifying instruction information includes a reception timing with which the master radio communication terminal receives a data communication signal, and
the second notifying signal is transmitted based on the reception timing, while the master radio communication terminal is receiving the data communication signal.

11. The terminal according to claim 9, wherein
the transmitting unit transmits the second notifying signal in a time-division method.

12. The terminal according to claim 9, wherein
the transmitting unit transmits the second notifying signal in a frequency band where no signal interference exists.

13. The terminal according to claim 9, wherein
the notifying instruction information includes a frequency hopping pattern to transmit the second notifying signal in a frequency-hopping method, and
the transmitting unit transmits the second notifying signal by using the frequency hopping pattern.

14. The terminal according to claim 9, further comprising:
a transmitting unit configured to transmit priority information for each of the radio communication terminals to the master radio communication terminal, the priority information including at least one of a power supply duration, a battery remaining amount, and a frequency with which a signal interference is detected;
wherein the master radio communication terminal acquires the priority information from the radio communication terminals, provides a higher priority, based on the priority information, to slave radio communication terminals having a longer power supply duration, a larger battery remaining amount, and a lower signal interference frequency, groups the radio communication terminals in accordance with magnitude of the reception power, and selects N slave radio communication terminals (N is an integer not smaller than 1) having a higher priority as notifying radio communication terminals from a group of largest reception power.

15. A receiver comprising:
a converting unit configured to convert a receiving signal to a signal shifted by a preset frequency;
a multiplying unit configured to multiply the receiving signal by the shifted signal;
an extracting unit configured to extract a baseband signal from the multiplied signal;
a detecting unit configured to detect a signal from the baseband signal.

16. A radio communication method comprising:
receiving, in a receiver, a notifying signal, transmitted by a transmitter, included in a first signal and a second signal, the first signal containing a first frequency band which is frequency-converted from a parameter signal including a parameter used to communicate with the receiver, the second signal containing a second frequency band which is frequency-converted from the parameter signal, the first frequency band and the second frequency band being distant from each other by a preset frequency;
converting, in the receiver, the notifying signal to a signal shifted by the preset frequency;
multiplying, in the receiver, the notifying signal by the shifted signal;
extracting, in the receiver, a baseband signal from the multiplied signal;
demodulating, in the receiver, the parameter from the baseband signal.
